(19) United States
(12) Patent Application Publication
(10) Pub. No.: US 2020/0052617 A1
(43) Pub. Date: Feb. 13, 2020

(54) DRIVE CIRCUIT FOR DRIVING AN ELECTRONICALLY COMMUTATED MOTOR

(71) Applicant: DIEHL AKO STIFTUNG & CO. KG, Wangen (DE)

(72) Inventors: MARTIN WEINMANN, BAD WALDSEE (DE); ANDREAS SCHMID, WANGEN IM ALLGAEU (DE); SEBASTIAN TINIUS, LAUF (DE)

(21) Appl. No.: 16/537,813

(22) Filed: Aug. 12, 2019

(30) Foreign Application Priority Data
Aug. 11, 2018 (DE) 10 2018 006 357.8

(51) Int. Cl. H02P 6/14; H02M 1/12; H02M 1/42; H02P 6/28

(52) U.S. Cl. CPC H02P 6/14; H02P 6/28; H02M 1/4233; H02M 1/126

(57) ABSTRACT

A drive circuit for driving an electronically commutated motor includes an AC terminal to which a power supply grid is connectable, a rectifier connected on the input side to the AC terminal, an inverter connected on the input side to the rectifier and to which the motor phases of the motor are connectable, and an intermediate DC voltage circuit between the rectifier and the inverter. An EMC filter includes a capacitive feedback coupling having at least one Y-capacitor connected between one pole of the intermediate DC voltage circuit and protective ground and overall incorporating stronger insulation than basic insulation.

### CROSS-REFERENCE TO RELATED APPLICATION

This application claims the priority, under 35 U.S.C. § 119, of German Patent Application DE 10 2018 006 357.8, filed Aug. 11, 2018; the prior application is herewith incorporated by reference in its entirety.

### BACKGROUND OF THE INVENTION

### Field of the Invention

The present invention relates to a drive circuit for driving an electronically commutated motor, specifically a motor of an electronic household appliance, and specifically such a drive circuit having an EMC filter and a power factor correction filter.

Drive circuits of that type, because of their high-frequency pulse characteristics, generate radio interference, which is propagated by using electromagnetic fields in clear space, and by conduction through power connection lines in the form of high-frequency voltages and currents. Consequently, drive circuits are customarily equipped with an EMC filter, through the use of which the power supply grid is intended to be protected against interference originating from the drive circuit and the connected motor.

German Patent DE 10 2007 058 376 B4, corresponding to U.S. Pat. No. 8,422,251, discloses a switched-mode power supply for an electronic household appliance, which is equipped with an EMC filter. The EMC filter respectively includes a reactance coil in the phase conductor connection and the neutral conductor connection to the power supply grid, a capacitor which is connected in parallel with the AC terminal, and a discharge resistor which is connected in parallel with that capacitor. The phase conductor connection and the neutral conductor connection are further respectively connected to protective ground through a Y-capacitor.

In many cases, drive circuits of that type are further equipped with an active power factor correction (PFC) filter, for example in a step-up converter topology. However, the use of an active PFC filter, as a result of an insulation fault on the above-mentioned capacitive feedback coupling to protective ground, can result in a permanent DC component on protective ground, which can compromise the correct operation of a fault current circuit-breaker.

### SUMMARY OF THE INVENTION

It is accordingly an object of the invention to provide an improved drive circuit for driving an electronically commutated motor, which overcomes the hereinafore-mentioned disadvantages of the heretofore-known circuits of this general type and which eliminates the above-mentioned disadvantages associated with the use of a conventional EMC filter.

With the foregoing and other objects in view there is provided, in accordance with the invention, a drive circuit for driving an electronically commutated motor including an AC terminal, to which a power supply grid is connectable, a rectifier which is connected on the input side to the AC terminal, an inverter which is connected on the input side to the rectifier and to which the motor phases of the motor are connectable, an intermediate DC voltage circuit between the rectifier and the inverter, and an EMC filter. According to the invention, the EMC filter includes a capacitive feedback coupling having at least one Y-capacitor, which is connected between one pole of the intermediate DC voltage circuit and protective ground and which, overall, incorporates stronger insulation than basic insulation.

Through the use of the at least one Y-capacitor, the capacitively coupled parasitic currents associated with the stray capacitances of the motor phases which are pulsed by the inverter are fed back to protective ground on the intermediate voltage circuit, and consequently are not propagated further outwards into the power supply grid through the AC terminal, where they might cause EMC interference.

Due to the use of stronger insulation than simple basic insulation in the capacitive feedback coupling between one pole of the intermediate DC voltage circuit and protective ground, upon the occurrence of an insulation fault on one part of the stronger insulation, the presence of the remaining fault-free part of the insulation can prevent the occurrence of a DC fault current leakage to protective ground, as a result of which the correct operation of a fault current circuit-breaker can be ensured and/or a simpler and more cost-effective fault current circuit-breaker (e.g. of type A) can be employed, wherein the protection of persons is improved by the remaining part of the insulation or by the correct operation of the fault current circuit-breaker.

Y-capacitors are protective capacitors, which are classified, for example, in IEC standard 60384-1. In that connection, according to the household appliances standard EN 60335, paragraph 3.3, basic insulation constitutes the insulation of live parts for the provision of fundamental protection against electric shock; additional insulation is an independent insulation provided additionally to basic insulation which, in the event of the failure of the basic insulation, ensures protection against electric shock; double insulation constitutes an insulation system including basic insulation and additional insulation; reinforced insulation constitutes the single insulation of live parts which, under the conditions defined in this standard, provides protection against electric shock which is equivalent to double insulation. Thus, for example, stronger insulation than basic insulation can be constituted by double insulation and/or by reinforced insulation. In general, stronger insulation than basic insulation preferably provides at least double the strength of basic insulation.

The capacitive feedback coupling to protective ground can be provided on one pole of the intermediate DC voltage circuit or on both poles of the intermediate DC voltage circuit. In the event of a single-pole capacitive feedback coupling only, this is preferably provided between the positive pole of the intermediate DC voltage circuit and protective ground.

The EMC filter, in addition to the capacitive feedback coupling of one pole of the intermediate DC voltage circuit to protective ground, preferably includes further capacitive, inductive and/or resistive elements.

The invention is not restricted to any specific type of motor. The motor in the motor configuration is in particular an electronically commutated motor such as, for example, a synchronous motor or an asynchronous motor, an AC motor, a three-phase AC motor, or similar.

The inverter of the drive circuit preferably includes an inverter bridge circuit, preferably having a plurality of power switches (e.g. MOSFETs or IGBTs with antiparallel connected diodes). The inverter, correspondingly to the connected motor, is preferably of a multi-phase configuration. The intermediate DC voltage circuit of the drive circuit preferably includes an intermediate circuit capacitor. The rectifier of the drive circuit is preferably configured as a bridge rectifier having a plurality of rectifier diodes.

In one configuration of the invention, the capacitive feedback coupling of the EMC filter includes a series-connected configuration of at least two Y-capacitors, each of which is provided with at least basic insulation. In the event of an insulation fault on one of the two Y-capacitors, the capacitive feedback coupling still includes one Y-capacitor with intact insulation, so that any DC fault current leakage to protective ground can be prevented, and the protection of persons is improved.

In a further configuration of the invention, the capacitive feedback coupling of the EMC filter is constituted by a Y-capacitor having double insulation or reinforced insulation. In the event of an insulation fault on one part of the double or reinforced insulation of the Y-capacitor, the capacitive feedback coupling still includes intact insulation, so that any DC fault current leakage to protective ground can be prevented, and the protection of persons is improved.

In one configuration of the invention, the EMC filter further includes a resistive and/or inductive attenuator disposed in series with the capacitive feedback coupling between the pole of the intermediate DC voltage circuit and protective ground.

In one configuration of the invention, the EMC filter is connected between the AC terminal and the rectifier.

In a further configuration of the invention, the drive circuit further includes a power factor correction filter (PFC filter), which is connected between the rectifier and the intermediate DC voltage circuit, and is preferably a PFC filter configured in a step-up converter topology.

Other features which are considered as characteristic for the invention are set forth in the appended claims.

Although the invention is illustrated and described herein as embodied in a drive circuit for driving an electronically commutated motor, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

Understanding of the above-mentioned and further characteristics and advantages of the invention will be clarified by the following description of a preferred and non-limiting exemplary embodiment, with reference to the attached drawing.

### BRIEF DESCRIPTION OF THE SEVERAL VIEWS OF THE DRAWING

The single FIGURE is a partially schematically represented circuit layout of a drive circuit with a connected motor, according to one exemplary embodiment of the invention.

### DETAILED DESCRIPTION OF THE INVENTION

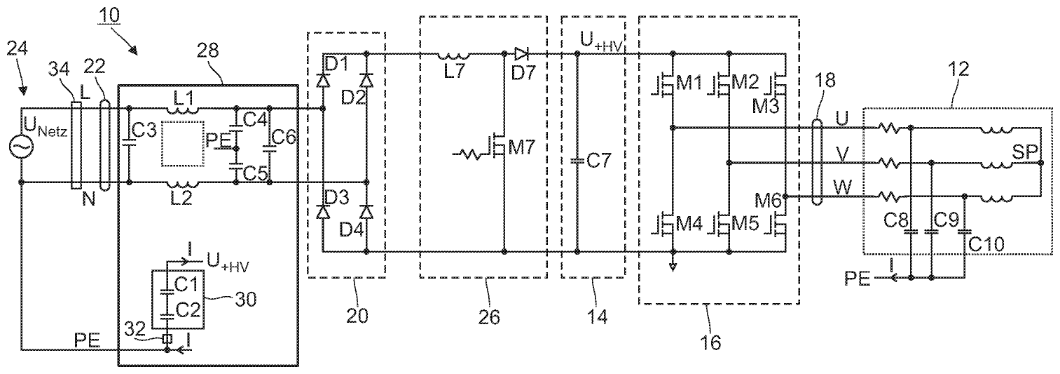

Referring now in detail to the single FIGURE of the drawing, there is seen an exemplary drive circuit 10 according to the invention for driving an electronically commutated motor 12. In the example shown in FIG. 1, the motor is a brushless three-phase AC motor 12 having three motor phases U, V, W, which are interconnected at a neutral point SP. The motor 12 is supplied by an intermediate DC voltage circuit 14 through an inverter 16. The intermediate DC voltage circuit 14 includes an intermediate circuit capacitor C7, and the inverter 16, in the present exemplary embodiment, includes a three-phase inverter bridge circuit having a total of six power switches M1 to M6 (e.g. MOSFETs or IGBTs with antiparallel connected diodes) in its half-bridges. The three motor windings of the motor 12 are connected through a motor cable to a motor phase terminal 18, which is connected to the three mid-taps of the half-bridges of the inverter 16. The motor 12 and the motor cable respectively include three motor phases U, V, W.

The input side of the intermediate DC voltage circuit 14 is connected to an AC terminal 22 through a rectifier 20. The drive circuit 10 can be connected through the AC terminal 22 to a power supply grid 24. In the example shown in FIG. 1, the power supply grid 24 is a single-phase power grid, the drive circuit 10 is connected to the phase conductor L and the neutral conductor N of the single-phase power grid, and the power supply grid 24 additionally includes a protective ground PE. In this example, the rectifier 20 includes a rectifier bridge circuit having a total of four rectifier diodes D1 to D4.

As represented in the FIGURE, a power factor correction (PFC) filter 26 is preferably further connected between the rectifier 20 and the intermediate DC voltage circuit 14. In this example, the PFC filter 26 is configured in a step-up converter topology, and specifically incorporates an inductance L7, a switch M7 and a rectifier diode D7.

The drive circuit 10 further includes a non-illustrated control device, for example in the form of a microcontroller, which actuates the power switches M1 to M6 of the inverter 16 and the switch M7 of the PFC filter 26 by using corresponding control signals.

The drive circuit 10 moreover incorporates an EMC filter 28 which, in the present exemplary embodiment, is connected between the rectifier 20 and the AC terminal 22. In the exemplary form of embodiment according to the FIGURE, this EMC filter 28 incorporates a first inductance L1 in the phase conductor connection to the phase conductor L of the power supply grid 24, a second inductance L2 in the neutral conductor connection to the neutral conductor N of the power supply grid 24, two capacitors C3, C6 for the capacitive coupling of the phase conductor L with the neutral conductor N, and two capacitors C4, C5 for the coupling of the phase conductor L or the neutral conductor N to the protective ground PE. In other forms of embodiment of the invention, the EMC filter 28 can also incorporate other and/or further capacitive, inductive or resistive elements.

As is illustrated in the FIGURE, the EMC filter 28 according to the invention further incorporates a capacitive feedback coupling 30 between one pole of the intermediate DC voltage circuit 14 (in this case the positive pole, represented by the intermediate circuit voltage U_{+HV}) and the protective ground PE. In the exemplary embodiment according to FIG. 1, this capacitive feedback coupling 30 includes a series-connected configuration of two Y-capacitors C1, C2, each of which is provided with simple basic insulation. In an alternative form of embodiment of the invention, the capacitive feedback coupling 30 includes one Y-capacitor C1, which is provided with double or reinforced basic insulation. Moreover, in the EMC filter 28, a resistive or inductive attenuator 32 is connected in series with the capacitive feedback coupling 30.

Through the use of the capacitive feedback coupling 30 of the two Y-capacitors C1 and C2 shown in the FIGURE, the capacitively coupled parasitic currents I associated with the stray capacitances C8, C9, C10 of the motor phases U, V, W, which are pulsed by the inverter 16, are fed back to the protective ground PE on the intermediate voltage circuit 14, and consequently are not propagated further outwards into the power supply grid 24 through the AC terminal 22, where they might cause EMC interference.

A fault current circuit-breaker 34 is preferably provided between the AC terminal 22 and the power supply grid 24. Due to the use of a capacitive feedback coupling 30 having stronger overall insulation than simple basic insulation, it can be achieved that, even in the event of an insulation fault on the feedback coupling 30, at least part of the insulation remains intact. Specifically in the case of drive circuits 10 having a PFC filter 26 in a step-up converter topology, it can thus be prevented that, in the event of an insulation fault on the feedback coupling 30, a critical DC fault current leakage to the protective ground PE occurs on the intermediate DC voltage circuit 14. Due to the use of a drive circuit 10 according to the invention having an EMC filter 28 with capacitive feedback coupling 30, a more cost-effective type A fault current circuit-breaker can thus be advantageously used. By way of comparison, in conventional drive circuits, the EMC filter of which incorporates a capacitive feedback coupling having only a single Y-capacitor with simple basic insulation between one pole of the intermediate DC voltage circuit and protective ground, more expensive type B fault current circuit-breakers, for example, are employed, the trip characteristics of which are not adversely affected by DC fault currents.

The following is a summary list of reference numerals and the corresponding structure used in the above description of the invention:
10 Drive circuit
12 Motor
14 Intermediate DC voltage circuit
16 Inverter
18 Motor phase terminal
20 Rectifier
22 AC terminal
24 Power supply grid
26 Power factor correction (PFC) filter
28 EMC filter
30 Capacitive feedback coupling
32 Attenuator
34 Fault current circuit-breaker
C1, C2 Y-capacitors of 30
C3-C6 Capacitances of 28
C7 Intermediate circuit capacitor of 14
C8-C10 Stray capacitances between the motor phases and protective ground
D1-D4 Rectifier diodes of 20
D7 Rectifier diode of 26
I Capacitively coupled parasitic current
L Phase conductor of 24
L1, L2 Inductances of 28
L7 Inductance of 26
M1-M6 Power switches of 16
M7 Switch of 26
N Neutral conductor of 24
PE Protective ground
SP Neutral point of 12
U, V, W Motor phases
U_{+HV} Intermediate circuit voltage
U_{Netz} System voltage

1. A drive circuit for driving an electronically commutated motor, the drive circuit comprising:
an AC terminal to be connected to a power supply grid;
a rectifier having an input side connected to said AC terminal;
an inverter to be connected to motor phases of the motor, said inverter having an input side directly or indirectly connected to said rectifier;
an intermediate DC voltage circuit connected between said rectifier and said inverter; and
an EMC filter including a capacitive feedback coupling having at least one Y-capacitor connected between one pole of said intermediate DC voltage circuit and protective ground, said capacitive feedback coupling having overall having stronger insulation than basic insulation.

2. The drive circuit according to claim 1, wherein said at least one Y-capacitor of said capacitive feedback coupling of said EMC filter includes a series-connected configuration of two Y-capacitors each having at least basic insulation.

3. The drive circuit according to claim 1, wherein said at least one Y-capacitor of said capacitive feedback coupling of said EMC filter is a Y-capacitor having double insulation or reinforced insulation.

4. The drive circuit according to claim 1, wherein said EMC filter includes at least one of a resistive or an inductive attenuator connected in series with said capacitive feedback coupling between said pole of said intermediate DC voltage circuit and protective ground.

5. The drive circuit according to claim 1, wherein said EMC filter is connected between said AC terminal and said rectifier.

6. The drive circuit according to claim 1, which further comprises a power factor correction filter connected between said rectifier and said intermediate DC voltage circuit.

7. The drive circuit according to claim 6, wherein said power factor correction filter is a power factor correction filter configured in a step-up converter topology.
